(19) United States
(12) Patent Application Publication
(10) Pub. No.: US 2013/0337419 A1
(43) Pub. Date: Dec. 19, 2013

(54) Method for Assisting in Weight Loss

(71) Applicant: Tatyana Daniels Beldock, Burlingame, CA (US)

(72) Inventor: Tatyana Daniels Beldock, Burlingame, CA (US)

(21) Appl. No.: 13/526,036

(22) Filed: Jun. 18, 2012

(51) Int. Cl. G09B 19/00

(52) U.S. Cl. 434/127

(57) ABSTRACT

A method that assists in weight loss includes distributing at least one plate to a user. The plate has a maximum dimension of no more than 10 inches, and a top surface that includes visual indicia representing a pattern defining four parts of equal area on the top surface in a discreet manner that avoids any indication of distribution of food groups over the parts of the plate. The method further includes distributing use instructions that recommend the distribution of food groups of a meal to be eaten on the plate over the four parts of the top surface as defined by the pattern. The pattern is preferably symmetrical about two orthogonal axes that cross one another at or near the center of the top surface of the plate, and has a luxurious style that cooperates with its discreet nature to allow for multiple purpose uses (including everyday use, entertaining, and/or portion control/dieting).

### BACKGROUND

1. Field

The present application relates to methods and systems that provide assistance in losing weight (commonly referred to as “dieting”).

2. Related Art

Obesity in the United States is 90% attributed to increased food intake, and 10% attributed to lack of physical activity. The Food and Drug Administration of the United States has not approved a weight loss drug in development in thirteen years due to steep safety hurdles and lackluster efficacy, so the available options are mainly diet and exercise.

Current diet and exercise weight loss offerings have limitations. Most diet plans have fairly complex rules, require substantial time commitments, come at a fairly high cost, and are generally not fun. Exercise plans can be difficult to fit into a busy schedule (such as a new mom that is caring for a new born).

### SUMMARY OF THE INVENTION

There is an unmet need for a method that provides assistance in losing weight in a manner that is safe, effective, credible, simple to implement (thus avoids complex rules), effortless (thus avoids substantial time commitment), discreet and luxurious.

The present application is a method that provides assistance in losing weight by distributing at least one plate to a user. The at least one plate has a maximum dimension no more than ten inches (preferably in the range between 8 inches and 10 inches and more preferably in a range between 9.0 inches and 9.25 inches), and has a top surface for holding food. The top surface includes visual indicia that represent a pattern on the top surface of the plate. The pattern defines four parts of equal area on the top surface. The pattern is preferably symmetrical about two orthogonal axes that cross one another at or near the center of the top surface of the plate. The pattern visually identifies the four parts of the plate in a discreet manner that avoids any indication of the distribution of food groups in different parts of the plate, while also retaining a luxurious style.

The method further includes distributing instructions for using the at least one plate to the user. The instructions recommend that the user distribute food groups of a meal to be eaten on the plate over the four parts of the top surface of the plate as defined by the pattern.

In one embodiment, the meal to be eaten on the plate includes three food groups including a protein group, a whole grain group, and a vegetable group. In this case, the instructions recommend that one single part of the top surface of the plate be used to hold the protein group of the meal, that another single part of the top surface of the plate be used to hold the whole grain group, and that another two parts of the top surface of the plate be used to hold the vegetable group. In this manner, one-quarter of the area of the top surface of the plate is recommended for holding the protein group of the meal, one-quarter of the area of the top surface of the plate is recommended for holding the whole grain group, and one-half of the area of the top surface of the plate is recommended for holding the vegetable group. These portions are useful for building a sensible and healthy diet according to well known nutritional science.

The instructions can be provided to the user in written form as part of the packaging of the at least one plate. The instructions can also be provided to the user in electronic form.

When the small-size plate of the present application is used as a substitute for a larger diameter plate (twelve inch diameter plates are typically used for dinner plates), the user can reduce caloric intake by up to 48%. Furthermore, the portion-control reinforced by the pattern of the small-size plate can result in an additional 11% fewer calories, for a total of 59% fewer calories consumed. The portion-control reinforced by the method is safe and effective in losing weight, credible, simple to implement (thus avoiding complex rules), and effortless (thus avoiding substantial time commitment). Furthermore, the discreet nature and luxurious style of the pattern of the small-size plate allows the plate to be used for multiple purposes, including everyday use, entertaining, and/or portion control/dieting.

### BRIEF DESCRIPTION OF THE DRAWINGS

FIG. 1A is a top view of a small size plate according to the present application.

FIG. 1B a schematic side view of the small size plate of FIG. 1A (note that the pattern on the top surface of the plate is not shown in this schematic view).

FIG. 1C is a schematic top view of the small size plate of FIG. 1A.

FIG. 2 is a diagram of exemplary instructions for using the small size plate of FIG. 1A.

### DETAILED DESCRIPTION OF THE PREFERRED EMBODIMENTS

A study in the journal Appetite found that people clean their plates an astonishing 91% of the time, no matter how much food is offered, even if they are no longer hungry. The Journal of the American Medical Association has found that American portion sizes have increased significantly since the 1970's. In fact, the Department of Nutrition and Food Studies at New York University found that American portions today exceed the FDA's serving size guidelines by a whopping 200 calories more per day. The World Health Organization has linked these staggering portion sizes with the expansion of the American waistline.

The key to eating less is portion control. Smaller portions contain fewer calories, and eating fewer calories is the best way to lose weight. One of the most effective approaches has also been one of the simplest: use smaller plates. Plate sizes have been rising in the U.S. over the last 50 years: the average plate in the 1960's was 9 inches. Today it is 12. The National Institutes of Health recommend replacing larger plates with smaller plates to eat less. “People basically eat what's put in front of them,” they say. “Try serving food on smaller plates if you'd like to eat less.”

Despite the huge drop in calories associated with smaller plates, a study at the University of Pennsylvania found that subjects were still satisfied and didn't miss the extra food. A study in the American Journal of Clinical Nutrition reported that subjects were often unaware that they had eaten more when given larger portions.

Based on the recent study in the journal Appetite, the data suggests that switching from a 12-inch plate to a 9-inch plate can reduce caloric intake by about 48%, or 275-350 fewer calories per meal. This calorie cut translates to roughly 14-18 pounds over 3 months, or 29-37 pounds over 6 months if the plate is used two meals per day.

Energy-dense foods like cheeseburgers contain far more calories per volume than low energy-density foods like vegetables. Because eating low-energy-dense foods leads to feeling fuller on fewer calories, you can get even better results by managing your food groups in a smart way:
The data of the study in the journal Appetite suggests that moving from average energy density foods to low energy density foods while moving to a smaller, portion-controlled plate can result in an additional 11% fewer calories, for a total of 59% fewer calories consumed.
This data further suggests that moving from average energy density foods on a 12-inch plate to low energy density foods on a 9-inch plate can cut calories by 435 calories per meal. That's roughly 23 pounds over 3 months, or 45 pounds over 6 months if the plate is used two meals per day.

The evidence in support of portion controlled plates is strong:
A study published in the Archives of Internal Medicine divided 130 patients with identical diets into two groups: one with conventional plates, and one with portion-controlled plates. Those using the portion-controlled plates lost 94% more weight than those who did not.
The analytic minds at Google found the data in support of small plates compelling, and decided to introduce smaller plates in their cafeterias. The result: Google employees lost on average lost an average of 10-15 pounds without ever committing to a formal diet.
In a series of six studies published in the American Journal of Clinical Nutrition, increasing portion size led to an increase in food and calories ingested. In just one example, increasing the portion size of a pasta entrée by 50% led to a 43% increase in intake, or 211 additional calories.

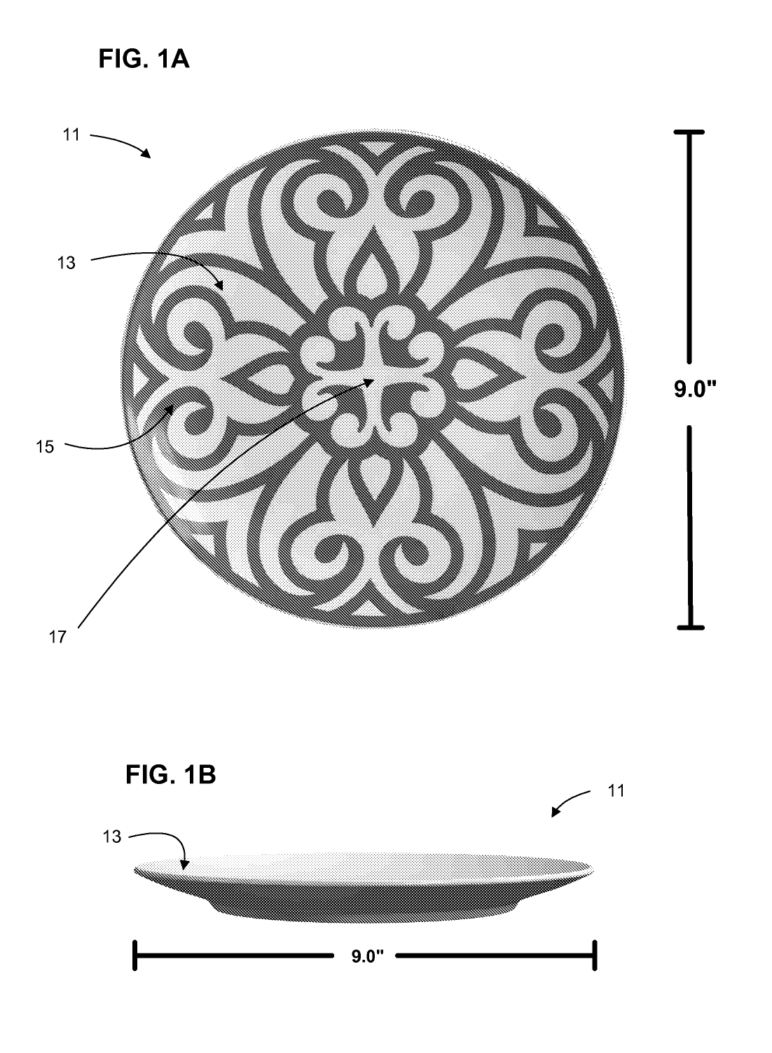

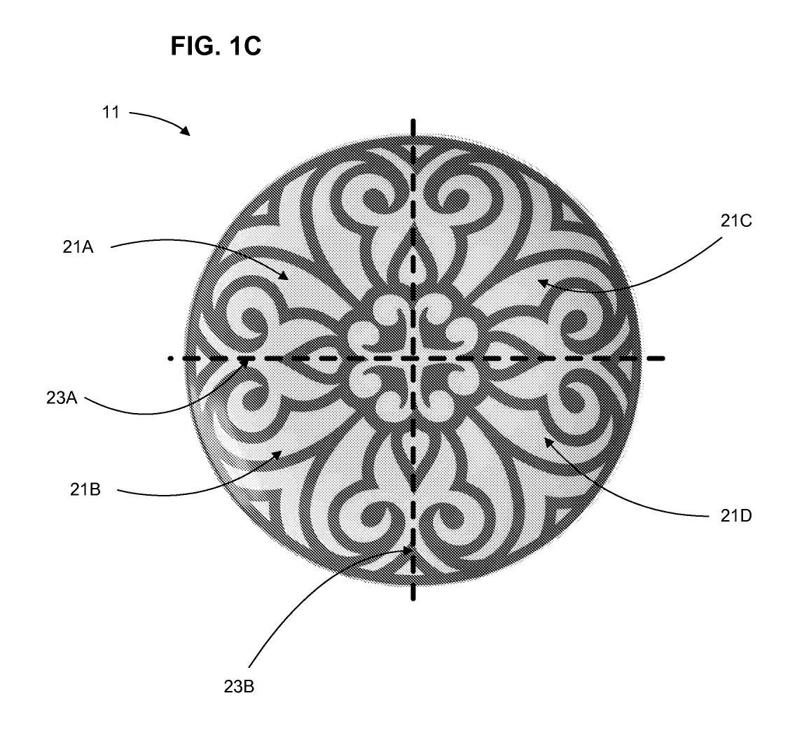

In accordance with the present application, a method is provided for assisting in weight loss. The method includes distributing one or more small size plates to a customer. The small size plate has a maximum dimension of no more than ten inches (more preferably in the range between 8 inches and 10 inches, and most preferably in the range between 9.0 inches to 9.25 inches). As best seen in in FIGS. 1A and 1B, an exemplary small size plate 11 is circular in shape with a diameter of nine inches. Other shapes and dimensions can be used. The top surface of the small size plate includes visual indicia this is printed or otherwise formed on the top surface. The visual indicia define a pattern 15 that partitions the top surface 13 of the plate 11 into four parts 21A, 21B, 21C and 21D of equal area as shown in FIG. 1C. The pattern 15 is symmetrical about two orthogonal axes 23A, 23B that cross one another at or near the center 17 of the top surface 13 of the plate 11 as shown. The two axes of symmetry 23A, 23B are equivalent to the axes of a Cartesian coordinate system whose origin lies at or near the center 17 of the top surface 13. In this case, the four parts 21A, 21B, 22C and 22D correspond to the four quadrants of the Cartesian coordinate system. Note that the axes of symmetry are not printed on the top surface 13, and the pattern 15 depicts the four parts 21A, 21B, 21C and 21D of the top surface 13 in a discreet manner that avoids any indication of the distribution of food groups over different parts of the top surface 13. The pattern 13 also does not outline the full extent of the peripheral boundaries of the four parts 21A, 21B, 21C, and 21D. Moreover, the pattern 15 conveys a luxurious style. The discreet nature and luxurious style of the pattern 13 allows the small size plate 11 to be used for multiple purposes, including everyday use, entertaining, and/or portion control/dieting.

The method also includes the distribution of instructions for using the small size plate 11. The instructions recommend that the user distribute the food groups of a meal to be eaten on the plate over the four parts of the top surface of the plate 11. The instructions can be provided in written form as part of the packaging of the small size plate. Alternatively, the instructions can be provided in electronic form as part of instructions on a website, via an email message, via a text message, email, or other suitable form of electronic communication communicated to the customer.

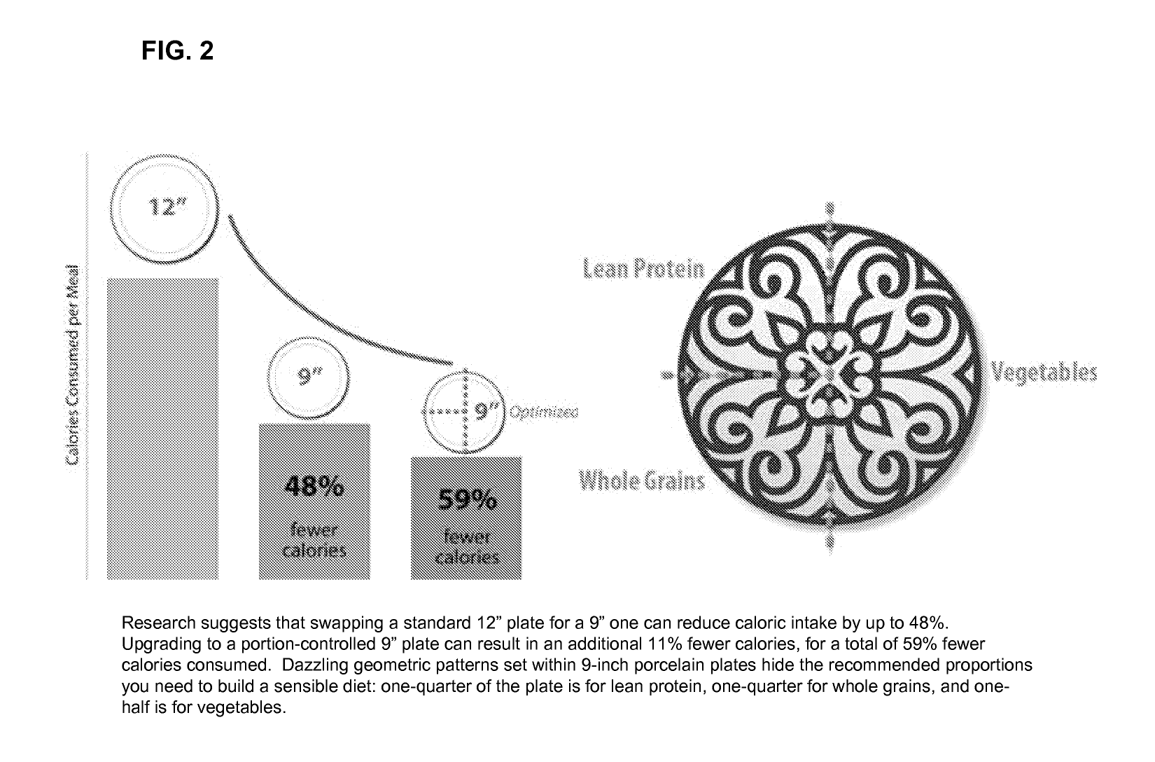

In one embodiment, the meal includes three food groups: a protein group, a whole grain group, and a vegetable group. In this case, the instructions can recommend that one single part of the top surface of the plate (for example, part 21A of FIG. 1C) be used to hold the protein group of the meal, that another single part of the top surface of the plate (for example, part 21B of FIG. 1C) be used to hold the whole grain group, and that another two parts of the top surface of the plate (for example, parts 21C and 21D of FIG. 1C) be used to hold the vegetable group. In this manner, one-quarter of the area of the top surface of the small size plate is recommended for holding the protein group of the meal, one-quarter of the area of the top surface of the small size plate is recommended for holding the whole grain group, and one-half of the area of the top surface of the small size plate is recommended for holding the vegetable group. These portions are useful for building a sensible and healthy diet according to well know nutritional science as set forth above. An example of suitable instructions for the small size plate of FIGS. 1A-1C is shown in FIG. 2.

It is also contemplated that a number of small sized plates 11 (such as a set of four, six, eight or twelve plates) can be packaged together for distribution to a customer. The distribution can involve sales through brick and mortor retail store(s) or online store(s), spas, health clubs, marketing through affiliates, direct sales, and corporate wellness programs.

The visual indicia (e.g., pattern 15 of FIGS. 1A-1C) can be formed as a glaze on the top surface of the small size plate, a decal or in some other suitable manner. The visual indicia can have a particular color (such as a red or blue color) that is different from the background color (typically a white or off-white color) of the top surface of the plate.

When the small-size plate of the present application is used as a substitute for a larger diameter plate (twelve inch diameter plates are typically used for dinner and lunch plates), the user can reduce caloric intake by up to 48%. Furthermore, the portion-control reinforced by the pattern of the small-size plate can result in an additional 11% fewer calories, for a total of 59% fewer calories consumed. The portion-control reinforced by the method is safe and effective in losing weight, credible, simple to implement (thus avoiding complex rules), and effortless (thus avoiding substantial time commitment). Furthermore, the discreet nature and luxurious style of the pattern of the small-size plate allows the plate to be used for multiple purposes, including everyday use, entertaining, and/or portion control/dieting. These advantages are not afforded by typical portion control plates that incorporate clear visual depictions or labels for the food groups that are to be distrubuted over the top surface of the plate.

There have been described and illustrated herein an embodiment of a method that provides assistance in losing weight. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A method that provides assistance in losing weight, the method comprising:
distributing at least one plate to a user, the at least one plate having a maximum dimension of no more than ten inches, and the plate having a top surface for holding food, the top surface including visual indicia that represents a pattern on the top surface of the plate, wherein the pattern defines four parts of equal area on the top surface in a discreet manner that avoids any indication of distribution of food groups in the four parts of the plate; and
distributing instructions for using the at least one plate to the user, the instructions recommending that the user distribute food groups of a meal to be eaten on the plate over the four parts of the top surface of the plate as defined by the pattern.

2. A method according to claim 1, wherein:
the meal to be eaten on the plate includes three food groups including a protein group, a whole grain group, and a vegetable group; and
the instructions recommend that one single part of the top surface of the plate be used to hold the protein group of the meal, that another single part of the top surface of the plate be used to hold the whole grain group, and that another two parts of the top surface of the plate be used to hold the vegetable group.

3. A method according to claim 1, wherein:
the instructions are provided in written form as part of the packaging of the at least one plate.

4. A method according to claim 1, wherein:
the instructions are provided in an electronic form.

5. A method according to claim 4, wherein:
the electronic form is selected from the group including a web site, an email message, and a text message.

6. A method according to claim 1, wherein:
the pattern is symmetrical about two orthogonal axes that cross one another at or near the center of the top surface of the plate.

7. A method according to claim 6, wherein:
the pattern does not outline the full extent of the peripheral boundaries of the four parts of the top surface of the plate.

8. A method according to claim 1, wherein:
the maximal dimension is in a range between 8 inches and 10 inches.

9. A method according to claim 1, wherein:
the maximal dimension is in a range between 9 inches and 9.25 inches.
